(19) United States
(12) Patent Application Publication
(10) Pub. No.: US 2004/0032576 A1
(43) Pub. Date: Feb. 19, 2004

(54) Exposure method and apparatus

(75) Inventor: Makoto Kondo, Kumagaya-shi (JP)

Correspondence Address: OLIFF & BERRIDGE, PLC, P.O. Box 19928, Alexandria, VA, 22320, US

(73) Assignee: Nikon Corporation

(21) Appl. No.: 10/636,570

(22) Filed: Aug. 8, 2003

Related U.S. Application Data
(63) Continuation of application No. 09/937,481, filed on Dec. 20, 2001, now abandoned.
Application No. 09/937,481 is a 371 of international application No. PCT/JP00/01540, filed on Mar. 14, 2000.

(30) Foreign Application Priority Data
Mar. 26, 1999 (JP) 11-83178

(51) Int. Cl. G03B 27/42

(52) U.S. Cl. 355/53

(57) ABSTRACT

An exposing method in which the total exposure of the portion where four patterns are adjacent to one another is almost equal to that of the other portions when patterns are transferred two-dimensionally by image stitching. Projected images (30A to 30D) of the pattern of a reticle are so stitched as to overlap with one another in both X and Y directions on a wafer to expose the wafer. The distribution of exposure of the rectangular corner parts, i.e., the areas (stitching portions (31)) where four projected images (30A to 30D) are adjacent to one another is determined according to the characteristic which is the product of a first characteristic gradually decreasing in the X direction and a second characteristic gradually decreasing in the Y direction.

### TECHNICAL FIELD

The present invention relates to an exposure method and an exposure apparatus which are to be used in a lithography process for manufacturing a device such as a semiconductor device, an image pick-up device (CCD or the like), a liquid crystal display device or a thin film magnetic head, and more particularly, which are suitably used for the case in which a plurality of patterns are transferred (stitch exposed) while carrying out a screen stitch, thereby exposing a large pattern.

### BACKGROUND ART

Generally, a conventional semiconductor integrated circuit is manufactured by repeating the step of transferring a pattern of a reticle as a mask onto each shot region on a wafer as a substrate. On the other hand, recently, an original pattern of one circuit pattern to be transferred is divided into a plurality of reticle patterns and the reticle patterns are transferred onto one shot region on a wafer while carrying out a screen stitch in order to manufacture a large-sized semiconductor integrated circuit device. More specifically, an exposure method of carrying out stitch exposure is used. The stitch exposure is also referred to as an “angle-of-view synthesis”.

When the stitch exposure is to be carried out by using a projection exposure apparatus such as a stepper, there is a fear that a pattern might be cut in the stitch portion (boundary portion) of the pattern images of reticles due to the drawing error of a reticle pattern, the aberration of a projecting optical system, the positioning error for positioning a reticle and a wafer and the like. There has conventionally been developed a method of superposing the stitch portions of adjacent pattern images with a small width to carry out exposure in order to prevent the pattern from being cut.

When the exposure is to be carried out while performing the screen stitch as described above, double exposure is executed in a superposing position to be the stitch portion. However, if the double exposure is simply carried out, there is a drawback that the amount of integral exposure in that portion is doubled and the line width of the stitch portion of the pattern is changed after development, etching and the like are carried out depending on the characteristic of a developer (resist) applied onto a wafer.

In order to avoid such a change in the line width of the pattern in the stitch portion, for example, there has been proposed a projection exposing apparatus provided with a beam attenuating portion for linearly decreasing the amount of transmitted light of the exposed light outward in a region corresponding to the stitch portion in an optical filter disposed on a conjugate plane with a reticle. In this case, for example, the superposed portion of two adjacent pattern images in a one-dimensional direction has the distributions of the amount of double exposure which are symmetrically inclined to each other. Therefore, the amount of integral exposure in the superposed portion is coincident with the amounts of integral exposure in other portions. In other words, the beam attenuating characteristic in the superposed portion is defined as a one-dimensional function.

Referring to the foregoing, recently, a semiconductor integrated circuit has further been large-sized. Therefore, it has further been required that the images of a plurality of reticle patterns should be stitched two-dimensionally with high precision to be exposed. In the case in which the screen stitch is to be thus carried out two-dimensionally in such a state that the beam attenuating characteristic of the superposed portion is decreased one-dimensionally in a predetermined direction, however, there is a drawback that the amount of integral exposure obtained after fourfold exposure is different from the amounts of integral exposure in other portions in a region where the corner portions of four adjacent pattern images are superposed and the line width of a circuit pattern formed in the corner portions is changed.

In consideration of the above-mentioned aspects, it is a first object of the present invention to provide an exposure method in which the amount of integral exposure in a portion in which four patterns are adjacent to each other is almost equal to the amounts of integral exposure (the amounts of exposure) in other portions in the case in which a plurality of patterns are exposed while carrying out a screen stitch two-dimensionally.

Furthermore, it is a second object of the present invention to provide an exposure apparatus capable of carrying out such an exposure method and a method of manufacturing the exposure apparatus.

Moreover, it is a further object of the present invention to provide a method of manufacturing a device or a mask using such an exposure method.

### DISCLOSURE OF THE INVENTION

The present invention provides a first exposure method which stitches and exposes a plurality of patterns on a substrate, thereby exposing a larger pattern than each of the patterns on the substrate, wherein a plurality of patterns (30A to 30D) are stitched and exposed such that partial regions of the patterns are superposed on each other in a first direction (X direction) and a second direction (Y direction) which intersect with each other, and, in a region (31) where four patterns are adjacent to each other, the four patterns are exposed such that corner portions of the four patterns are superposed on each other, with exposure amounts of the corner portions of the four patterns being respectively set based on a characteristic obtained by multiplying a first characteristic which gradually decreases outward along the first direction by a second characteristic which gradually decreases outward along the second direction when respectively exposing the four patterns.

According to the above-mentioned present invention, the beam attenuating characteristics of the exposure amounts in the corner portions of the four patterns are set two-dimensionally, respectively. Therefore, the amount of integral exposure obtained after fourfold exposure is almost equal to the amounts of integral exposure in other portions. Moreover, the two-dimensional characteristic is obtained by multiplying one-dimensional characteristics intersecting each other. Therefore, it is possible to easily manufacture a beam attenuating filter having such a beam attenuating characteristic, for example.

In this case, it is desirable that when the corner portion of one of the four adjacent patterns is exposed, an exposure amount at the corner portion should be set to have a value proportional to (x/a)·(y/b), wherein widths in the first and second directions of the corner portion are respectively represented by “a” and “b” and coordinates increasing inward in the corner portion along the first and second directions are respectively represented by “x” and “y” with an apex of the corner portion being set to be a point of origin. By setting respective characteristics in three other corner portions to be gradually rotated, the amount of integral exposure in the corner portion obtained after the fourfold exposure is accurately coincident with the amounts of integral exposure in other portions.

The present invention provides a second exposure method which stitches and exposes a plurality of patterns on a substrate, thereby exposing a larger pattern than each of the patterns on the substrate, wherein a plurality of patterns (32A to 32D) are stitched and exposed such that partial regions of the patterns are superposed on each other in a first direction (X direction) and a second direction (Y direction) which intersect with each other, and, in a region (33, 34) in which four patterns are adjacent to each other, of a first pair of the patterns and a second pair of the patterns which are obliquely opposed to each other, the first pair of patterns (32A, 32D) are exposed with respective rectangular corner portions of the first pair of the patterns being superposed on each other and the second pair of patterns (32B, 32C) are exposed with corner portions (33, 34) of respective triangles of the second pair of patterns being provided adjacently to each other in the rectangular corner portions.

According to the above-mentioned present invention, the corner portions of the three adjacent patterns (32A, 32B, 32D) are superposed and exposed in one of the triangular regions (33) in a region where the four patterns are provided adjacently to each other, and the corner portions of the three adjacent patterns (32A, 32C, 32D) are superposed and exposed in the other triangular region (34). In the corner portions, the amounts of exposure are decreased outward with predetermined characteristics, respectively. Therefore, the amount of integral exposure is almost equal to the amounts of integral exposure in other portions.

Next, the present invention provides a first exposure apparatus which transfers a pattern of a mask (R) onto a substrate (W), comprising an illumination optical system (1 to 3, 6 to 8) which illuminates the mask, a field stop (4) which is disposed at a substantially conjugate position with respect to a pattern plane of the mask in the illuminating optical system and which serves to set an illuminating region on the mask, a substrate stage (25) which positions the substrate, and a beam attenuating filter (55) which is provided on a plane in proximity to the pattern plane of the mask a conjugate plane with respect to the pattern plane or a plane in proximity to the conjugate plane, and which serves to set a transmittance for illumination light for exposing a region corresponding to at least one corner portion of a pattern region having an external shape substantially parallel with a first direction and a second direction, which intersect each other, of the pattern plane based on a characteristic obtained by multiplying a first characteristic which gradually decreases outward along the first direction by a second characteristic which gradually decreases outward along the second direction. By the exposure apparatus, the first exposure method according to the present invention can be used.

Moreover, the present invention provides a second exposure apparatus comprises a beam attenuating filter (56) having the following characteristic in place of the beam attenuating filter of the first exposure apparatus. More specifically, the beam attenuating filter serves to set, of first and second pairs of corner portions, which are opposed obliquely to each other, of a pattern region having an eternal shape substantially parallel with a first direction and a second direction, which intersect each other, of the pattern plane, a transmittance for illumination light for exposure in a region corresponding to the first pair of corner portions based on a first characteristic which gradually decreases outward along the first direction or a second characteristic which gradually decreases outward along the second direction, and to set a transmittance for illumination light for exposure in a region corresponding to a second pair of corner portions, in a triangular region expanded outward along an opposed direction of the pair of corner portions, based on a characteristic obtained by adding the first characteristic which gradually decreases outward along the first direction and the second characteristic which gradually decreases outward along the second direction. By the second exposure apparatus, the above-mentioned second exposure method can be used.

The present invention provides a third exposure method which respectively transfers a pattern onto at least two regions having peripheral portions partially superposed on each other on a substrate, wherein in order to obtain at least one of position information and rotation information of a beam attenuating filter which gradually decreases, in a portion in which the at least two regions are superposed on each other, light amount on the substrate of illumination light illuminated on the pattern, at least one mark pattern provided on the beam attenuating filter is detected.

According to the above-mentioned present invention, because the light amount on the substrate of the illumination light illuminated on the pattern through the beam attenuating filter is gradually decreased in a portion in which the at least two regions are superposed on each other, the amount of integral exposure in the portion is almost equal to the amounts of integral exposure in other portions. According to the present invention, moreover, the mark pattern provided on the beam attenuating filter is detected to obtain at least one of the position information and the rotation information of the beam attenuating filter. Based on the information thus obtained, consequently, it is possible to enhance relative positioning precision of the beam attenuating filter and the pattern and to increase the line width precision of a device after stitch exposure and the like.

In this case, it is desirable that the relative relationship between the mask on which the pattern is formed and the beam attenuating filter should be regulated based on the information thus obtained.

Moreover, it is desirable that at least one of position and inclination of the beam attenuating filter with respect to an optical axis in an optical system in which the beam attenuating filter is disposed should be regulated based on the information thus obtained.

Furthermore, the present invention provides a third exposure apparatus which respectively transfers a pattern onto at least two regions having peripheral portions partially superposed on each other on a substrate respectively, comprising a beam attenuating filter which gradually decreases light amount on the substrate of illumination light illuminated on the pattern in a portion in which the at least two regions are superposed on each other, and a detecting device which detects at least one mark pattern provided on the beam attenuating filter in order to obtain at least one of position information and rotation information of the beam attenuating filter. The above-mentioned third exposure method according to the present invention can be used by the above-mentioned third exposure apparatus.

In this case, it is desirable that an actuator which drives the beam attenuating filter should further be provided in order to regulate at least one of position and rotation of the beam attenuating filter.

Moreover, it is desirable that the detecting device should detect at least one of relative position information and relative rotation information between the beam attenuating filter and a mask on which the pattern is formed.

Furthermore, it is desirable that the beam attenuating filter should be disposed to be shifted from a pattern plane of a mask on which the pattern is formed or a conjugate plane thereof.

The present invention provides a method of manufacturing a device comprising the step of transferring a device pattern onto a photosensitive substrate by using the exposing method according to the present invention or the exposing apparatus according to the present invention.

Moreover, the present invention provides a method of manufacturing a mask using the exposing method according to the present invention, comprising a step of transferring a plurality of mask patterns onto a mask substrate while carrying out a screen-stitching by using the exposing method. In this case, a mask can be mass produced with higher precision and higher throughput by reducing and transferring a plurality of mask patterns, than those in a method of directly drawing a mask pattern on a mask substrate by using an electron beam drawing device or the like.

Furthermore, the present invention provides a mask having, as a mask pattern, a device pattern transferred while carrying out a screen stitch by the exposing method or exposing apparatus according to the present invention.

The present invention provides a first method of manufacturing an exposure apparatus which transfers a mask pattern onto a substrate, comprising an illumination optical system which illuminates the mask, a field stop which is disposed at a substantially conjugate position with respect to a pattern plane of the mask in the illuminating optical system and serves to set an illuminating region on the mask, a substrate stage which positions the substrate, and a beam attenuating filter disposed on a plane in proximity to the pattern plane of the mask, a conjugate plane with respect to the pattern plane or a plane in proximity to the conjugate plane, and serves to set a transmittance for illumination light for exposing a region corresponding to at least one corner portion of a pattern region having an external shape substantially parallel with in a first direction and a second direction, which intersect each other, of the pattern plane based on a characteristic obtained by multiplying a first characteristic which gradually decreases outward along the first direction by a second characteristic which gradually decreases outward along the second direction, which are assembled with a predetermined positional relationship.

Moreover, the present invention provides a second method of manufacturing an exposure apparatus which transfers a mask pattern onto a substrate, comprising an illumination optical system which illuminates the mask, a field stop which is disposed at a substantially conjugate position with respect to a pattern plane of the mask in the illuminating optical system and serves to set an illuminating region on the mask, a substrate stage which positions the substrate, and a beam attenuating filter disposed on a plane in proximity to the pattern plane of the mask, a conjugate plane with respect to the pattern plane or a plane in proximity to the conjugate plane, and serves to set, of first and second pairs of corner portions, which are opposed obliquely to each other, of a pattern region having an external shape substantially parallel with a first direction and a second direction, which intersect each other, of the pattern plane, a transmittance for illumination light for exposure in a region corresponding to the first pair of corner portions based on a first characteristic which gradually decreases outward along the first direction or a second characteristic which gradually decreases outward along the second direction, and to set a transmittance for illumination light for exposure in a region corresponding to a second pair of corner portions, in a triangular region expanded outward along an opposite direction of the pair of corner portions, based on a characteristic obtained by adding the first characteristic which gradually decreases outward along the first direction and the second characteristic which gradually decreases outward along the second direction, which are assembled with a predetermined positional relationship.

Furthermore, the present invention provides a third method of manufacturing an exposure apparatus which respectively transfers a pattern onto at least two regions having peripheral portions partially superposed on each other on a substrate, comprising a beam attenuating filter which gradually decreases, in a portion in which the at least two regions are superposed on each other, light amount on the substrate of illumination light illuminated on the pattern and a detecting device which detects at least one mark pattern provided on the beam attenuating filter in order to obtain at least one of position information and rotation information of the beam attenuating filter, which are assembled with a predetermined positional relationship.

### BRIEF DESCRIPTION OF THE FIGURES IN THE DRAWINGS

FIG. 1 is a view showing a schematic structure of a projection exposing apparatus to be used in an example of an embodiment of the present invention.

FIG. 2 is an enlarged view showing an example of the structure of a reticle blind 4 in FIG. 1.

FIG. 3 is an enlarged perspective view showing the structure of a movable stage of a positioning device 5 in FIG. 1.

FIG. 4 is a diagram showing transmittance distribution of a density filter 55 in FIG. 1.

FIG. 5 is a diagram showing a projected image obtained by carrying out a transfer while performing a screen stitch by using the density filter 55 in FIG. 4.

FIG. 6 is a diagram illustrating a method of removing an incomplete portion through the reticle blind.

FIG. 7 is a diagram showing the transmittance distribution of a density filter 56 according to another example of the embodiment of the present invention.

FIG. 8 is a diagram showing a projected image obtained by carrying out a transfer while performing a screen stitch by using the density filter 56 in FIG. 7.

FIG. 9 is a view showing a main part of the embodiment in which a thin film for dustproof is provided in the density filter 55, a part of which is taken away.

### BEST MODE FOR CARRYING OUT THE INVENTION

A first embodiment of the present invention will be described below with reference to the drawings.

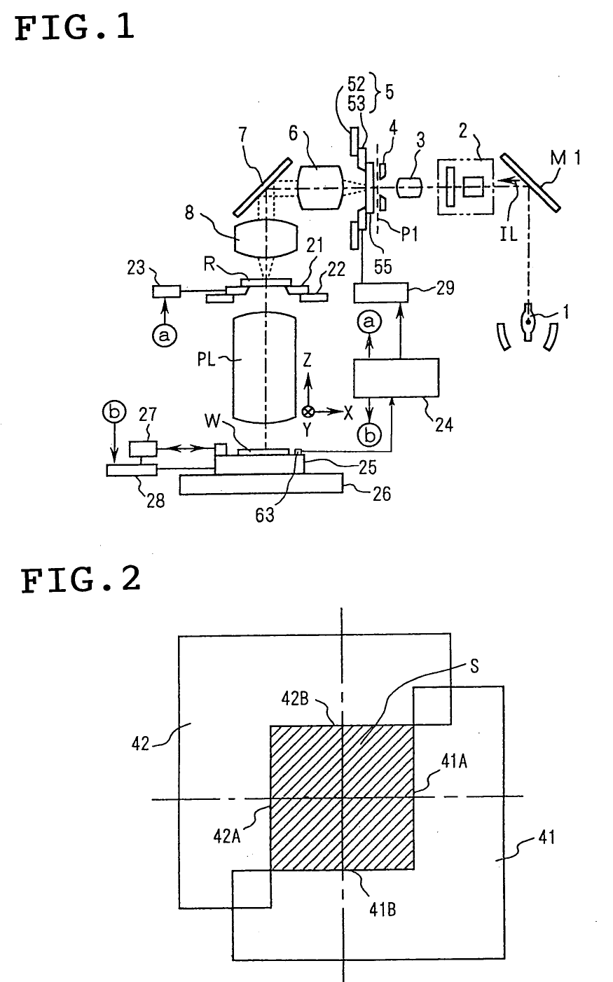

FIG. 1 shows the schematic structure of a projection exposing apparatus according to the present example. In FIG. 1, illuminating light (exposed light) IL for exposure which is emitted from a light source 1 during the exposure passes through a shutter which is not shown and is reflected by a mirror Ml, and is then incident on an illuminance uniforming optical system 2 including an input lens, an optical integrator (a fly eye lens or a rod lens) and the like so that an illuminance distribution is made uniform. A numerical aperture of the illuminating light, and furthermore, an aperture stop (not shown) for determining a coherence factor (a value) are provided on a Fourier transformation plane for the pattern plane of a reticle R to be transferred in the illumination uniforming optical system 2.

The illuminating light IL passing through the illuminance uniforming optical system 2 is incident on a reticle blind 4 to be a variable field stop through a relay lens 3. As shown in FIG. 2, by way of example, the reticle blind 4 determines an illuminating region (exposure angle of view) on the reticle R through a variable opening (a region shown in a slant line) S surrounded by four edges 41A, 41B, 42A and 42B of two L-shaped movable light shielding plates 41 and 42.

In FIG. 1, the illuminating light IL passing through the reticle blind 4 gains a suitable illumination distribution when passing through a density filter 55 to carry out exposure (stitch exposure) while performing a screen stitch as will be described below. More specifically, the density filter 55 to be a beam attenuating filter has a transmittance distribution for making the amount of integral exposure of a stitching portion equal to the amounts of integral exposure in other portions when carrying out the stitch exposure (the details will be described below). The illuminating light passing through the density filter 55 illuminates the pattern plane (lower plane) of the reticle R forming an original pattern for a transfer through a relay lens 6, a mirror 7 for bending an optical path, and a condenser lens 8. If a conjugate plane with the pattern plane of the reticle R with respect to the relay lens 6 and the condenser lens 8 is represented by a plane P1, the plane on which the reticle blind 4 is to be provided is close to the plane P1 and a plane of the density filter 55 on which a filter is to be formed is set to be in a position slightly shifted from the plane P1 toward the reticle R side. By the action of the density filter 55, the illuminating light L1 has an illumination distribution to be gradually reduced in the peripheral portion of the pattern region of the reticle R, and a pattern in the illuminating region of the reticle R is projected onto a wafer W coated with a photoresist to be a substrate with a projecting magnification β (β is ¼, ⅕ or the like) through a projecting optical system PL.

The light source 1, the mirror M1, the illumination uniforming optical system 2, the relay lens 3, the reticle blind 4, the density filter 55, the relay lens 6, the mirror 7, the condenser lens 8 and the like constitute the illuminating optical system. While i rays (a wavelength of 365 nm) of a mercury lamp are used as the illuminating light IL in the present example, it is desirable that ultraviolet rays having a shorter wavelength, for example, an excimer laser beam such as KrF (a wavelength of 248 nm) or ArF (a wavelength of 193 nm), or an F₂ laser beam (a wavelength of 157 nm), an Ar₂ laser beam or YAG laser harmonics should be used for the illuminating light IL in order to increase a resolution. By taking a Z-axis in parallel with the optical axis of the projecting optical system PL, an X-axis-in parallel with the paper of FIG. 1 in a plane perpendicular to the Z-axis, and a Y-axis perpendicularly to the paper of FIG. 1, description will be given.

In this case, the reticle R is held on a reticle stage 21, and the reticle stage 21 is slightly moved in X, Y and rotation directions over a reticle base 22, thereby positioning the reticle R. The position of the reticle stage 22 is measured by a laser interferometer incorporated in a reticle stage driving system 23, and the reticle stage driving system 23 controls the operation of the reticle stage 21 based on the measured value and control information sent from a main control system 24 for generalizing and controlling the operation of the whole apparatus.

On the other hand, the wafer W is held on a wafer stage 25 through a wafer holder which is not shown, and the wafer stage 25 is stepped and moved in the X and Y directions over a wafer base 26. The position in an X-Y plane of the wafer stage 25 is measured by the laser interferometer 27, and a wafer stage driving system 28 controls the operation of the wafer stage 25 based on the measured value and control information sent from the main control system 24. Furthermore, the wafer stage 25 adapts the surface of the wafer W into the image plane of the projecting optical system PL through an autofocus method. An illuminance sensor 63 for collecting and photoelectrically converting the light passing through a pin hole is fixed into the vicinity of the wafer W on the wafer stage 25, and the detection signal of the illuminance sensor 63 also functioning as a mark detecting system is supplied to the main control system 24.

Moreover, a reticle loader for exchanging the reticle on the reticle stage 21 which is not shown and a reticle library having a plurality of reticles accommodated therein which is used for a screen stitch are provided in the vicinity of the reticle stage 21 and the reticle R on the reticle stage 21 can be quickly exchanged with another reticle.

During the exposure, when the reduced image of the pattern of the reticle R is completely exposed to a predetermined portion in one shot region on the wafer W, a portion corresponding to a next shot region on the wafer W is moved to the exposure region of the projecting optical system PL to carry out the exposure through the stepping movement of the wafer stage 25. This operation is repeated by a step and repeat method. Then, the reticle R is exchanged with another reticle and the reduced image of the pattern of the exchanged reticle is exposed while carrying out a screen stitch for each shot region on the wafer W, and the exchange of the reticle and the stitch exposure are subsequently repeated.

A large-sized reticle may be used as the reticle R in place of a plurality of reticles and a plurality of patterns sequentially selected from the pattern plane of the reticle by the reticle blind 4 may be transferred onto each shot region on the wafer while carrying out a screen stitch.

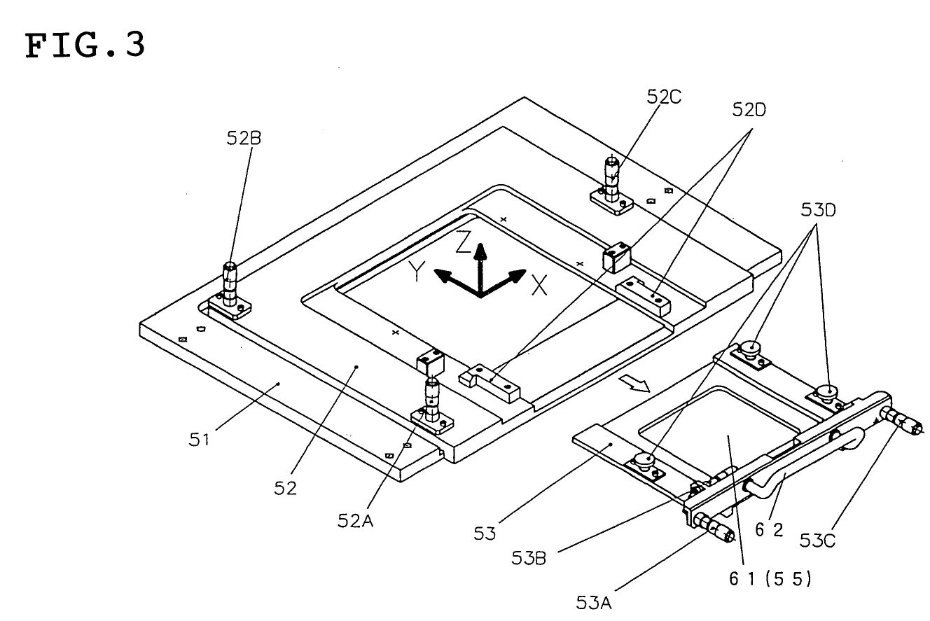

Moreover, the density filter 55 is provided to be movable over a base which is not shown (a base 51 in FIG. 3) through a movable table 53 and a movable table 52 with a degree of freedom of 6, and the main control system 24 can control the position and inclination of the density filter 55 through the driving system 29. The positioning device 5 of the density filter 55 is constituted by the movable tables 52 and 53 and the like. Similarly, the shape of the opening of the reticle blind 4 can also be set by the main control system 24 through a driving system which is not shown.

In the projection exposing apparatus according to the present example, the reduced images of a plurality of reticle patterns are exposed (stitch exposed) while carrying out a screen stitch as described above in the exposure to each shot region on the wafer W. In this case, the exposure is carried out by superposing stitch portions (coupled portions) having predetermined widths in the boundary portion of the reduced images of two adjacent patterns, and the exposure is carried out by superposing corner portions to be stitch portions on respective corners of the reduced images of four patterns in a region in which the four reduced images are adjacent to each other. Consequently, a circuit pattern finally formed in the stitch portion can be prevented from being cut.

However, when a plurality of reduced images are simply superposed and exposed, the amount of integral exposure is more increased than the amounts of integral exposure in other portions. In the present example, therefore, the illuminance in a peripheral portion (and the amount of exposure) is reduced when exposing the reduced image of the pattern of each reticle by using the density filter 55. When carrying out the stitch exposure, a circuit pattern for a device is not always present in a stitch portion (for example, the superposed portion of a first portion in one shot region to be exposed by the illuminating light IL during the transfer of a first pattern and a second portion in one shot region to be exposed by the illuminating light IL during the transfer of a second pattern) depending on a reticle pattern or a connecting portion is not always provided even if the circuit pattern is present. Also in these cases, the density filter 55 is effective for adapting the amount of integral exposure to other regions. Description will be given to a method of supporting the density filter 55, the structure of the filter and a method of using the filter.

In FIG. 1, first of all, it is desirable that the filter surface of the density filter 55 should be theoretically provided on the conjugate plane P1 with the pattern plane of the reticle R in order to set an illuminance distribution over the pattern plane of the reticle R depending on the transmittance distribution of the filter surface of the density filter 55 in the present example. In this case, if defect portions or foreign matters such as dust are present on the filter surface, there is a fear that the defect portions and the foreign matters might be transferred onto the wafer W together with the pattern of the reticle R. Therefore, the filter surface of the density filter 55 is provided in a position slightly apart from the plane P1 toward the reticle side or the light source side (a defocused position). Under such an environment that the foreign matters on the filter surface can be decreased, the surface of the density filter 55 may be provided on the plane P1.

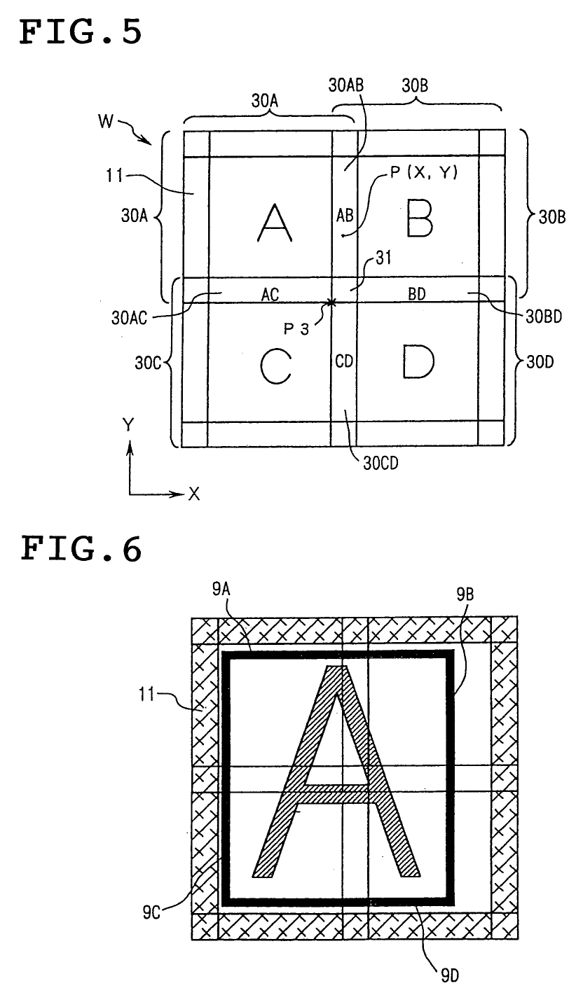

In this case, it is necessary to control the illuminance distribution of the illuminating light IL in the stitch portion with high precision and to increase relative positioning precision between the reticle R and the density filter 55 in order to enhance precision in the line width of a device after the stitch exposure. For example, in FIG. 5, in the case in which a projected image 30A and a projected image 30B which are adjacent to each other in the X direction are superposed and exposed in a stitch portion AB, it is necessary to maintain a width in the X direction of the stitch portion 30AB to have a constant value and it is necessary to cause the amount of defocus for the plane P1 of the density filter 55 in FIG. 1 to be almost equal to each other on the periphery based on the uniformity of the illuminance distribution.

In order to set the relative positional relationship between the reticle R and the density filter 55 to be in a predetermined state, the positioning device 5 including the movable tables 52 and 53 is used.

FIG. 3 shows an example of the structure of the positioning device 5 for the density filter 55. In FIG. 3, directions corresponding to the X, Y and Z directions over the wafer stage 25 in FIG. 1 are set to be X, Y and Z directions, respectively. The density filter 55 is provided to cover an opening 61 of the movable table 53, the movable table 53 is provided to cover the opening of the movable table 52, and the movable table 52 is fixed onto the base 51. In this case, the movable table 52 is provided such that it can be slightly adjusted with a degree of freedom 3 including translation in the X and Y directions with respect to the base 51 through triaxial driving motors 52A to 52C and rotation around the Z axis, and the movable table 53 is provided such that it can be slightly adjusted with a degree of freedom of 3 including translation in the Z direction with respect to the movable table 52 through three driving motors 53D and rotation around the X and Y axes. The six-axis driving motors 52A to 52C and 53D are provided with encoders for detecting the amount of movement or a rotating angle respectively, and the results of detection obtained by the encoders are supplied to the driving system 29 in FIG. 1.

In FIG. 1, moreover, the main control system 24 moves the illuminance sensor 63 to the exposure region of the projecting optical system PL to start the illumination of the illuminating light IL for the exposure, and then drives the wafer stage 25 across the exposure region through the illuminance sensor 63 to fetch the detection signal of the illuminance sensor 63 corresponding to the coordinates of the wafer stage 25, thereby monitoring the position and rotating angle of the density filter 55. In this case, for example, marks for alignment are provided to correspond to both the density filter 55 and the reticle R and the positions of the images of the marks for alignment are also detected. Consequently, it is possible to detect the positional relationship between a projected image on the reticle R of the density filter 55 and the reticle R (at least one of a positional relationship in the X direction, a positional relationship in the Y direction and relative rotation around the Z axis) with high precision. The main control system 24 controls the operation of the driving motors 52A to 52C and 53D through the driving system 29 to position the density filter 55 such that the positional relationship thus detected is a predetermined relationship.

In this case, the amounts of defocus in corresponding positions may be obtained based on the contrast of the images of the marks for alignment in two places on the periphery of the density filter 55 and a position in a direction along the optical axis of the density filter 55 may be controlled such that the amounts of defocus are equal to each other. Consequently, it is possible to regulate the position in the Z direction of the density filter 55 and the amount of one-dimensional inclination (rotating angle). Only the image of one mark for alignment of the density filter 55 may be detected by the illuminance sensor 63 to regulate the amount of defocus of the density filter 55 or the images of marks for alignment provided in at least three places of the density filter 55 may be detected by the illuminance sensor 63 to regulate the amount of two-dimensional inclination (rotating angle) in addition to the amount of defocus of the density filter 55. Moreover, when at least the position (the amount of defocus) and the rotating angle in the Z direction of the density filter 55 are to be detected, only the mark for alignment of the density filter 55 may be detected by the illuminance sensor 63 without using the mark for alignment on the reticle R. Furthermore, a reference mark provided in the reticle stage 21 may be used in place of the mark for alignment on the reticle.

In FIG. 3, an operator may manually regulate the position of the density filter 55 during the interruption of the exposure, for example, by using a manual driving micrometer head in place of the driving motors 52A to 52C and 53D.

Moreover, the density filter 55 may be exchanged with another density filter having a transmittance distribution. When the density filter is to be thus exchanged, it is preferable that the movable table 53 should be pulled out of the movable table 52 by using a handle 62 provided in the movable table 53.

Next, the filter transmittance distribution of the density filter 55 will be described.

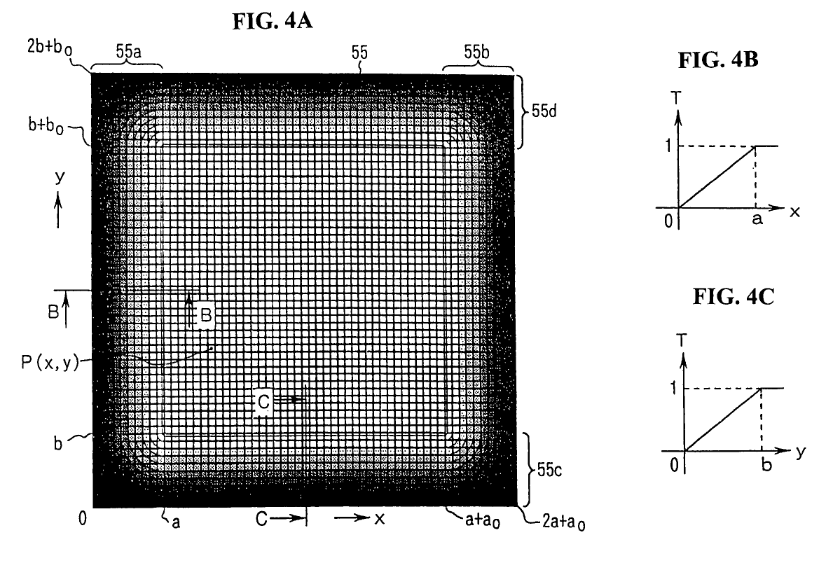

FIG. 4(a) is a diagram showing the transmittance distribution of the filter portion of the density filter 55. In FIG. 4(a), directions corresponding to the X and Y directions in FIG. 1 are set to be x and y directions, respectively. Moreover, a grating pattern formed in the filter portion of the density filter 55 is virtually drawn to indicate coordinates. Actually, a transmittance in the filter portion is substantially changed continuously between 1 (100%) and 0 (0%). More specifically, a large number of very fine dot patterns are formed in the filter portion to obtain a desirable transmittance distribution by changing the size and density of each dot pattern depending on positions. A transmission substrate itself for the density filter 55 has a transmittance of 1. Moreover, it is desirable that the size and density of the dot pattern should be regulated to set a transmittance distribution thereof to obtain a desired distribution of the amount of illuminating light on the reticle or the wafer in consideration of diffracted light generated from the dot pattern and the optical characteristics (distortion and the like) of the illuminating optical system.

Such a density filter 55 can be manufactured through the steps of forming a light shielding film such as chromium on a transmission substrate, applying an electron beam resist thereon, drawing a corresponding pattern thereon by an electron beam drawing device, and then carrying out development, etching, resist separation and the like. Also in the case in which a defect, a continuous edge or the like is formed in a partial region in the manufacturing process, the filter surface is defocused from the conjugate plane with the reticle R so that the defect or the like is not transferred onto the wafer. In consideration of precision in drawing of the electron beam drawing device during the manufacture of the density filter 55, a tolerance for the error of the amount of exposure (dose) on the wafer and the like, the amount of defocus of the density filter 55 is set.

In the rectangular filter portion of the density filter 55 in FIG. 4(a), the widths of stitch portions (superposed portions) 55a and 55b of both ends in the x direction which are superposed and exposed when carrying out stitch exposure are represented by a, the widths of stitch portions (superposed portions) 55c and 55d of both ends in the y direction are represented by b, and the widths in the x and y directions of an internal region surrounded by the stitch portions 55a to 55d are represented by a₀ and b₀, respectively. Moreover, the range in the x and y directions of the filter portion is as follows when the lower left apex of the rectangular filter portion is set to be an origin in the positions x and y.

0≦x≦2a+a₀, 0≦y≦2b+b₀

If a transmittance at a point P having coordinates (x, y) in the filter portion is represented by T (x, y), the transmittance T (x, y) is set to TAᵢ for each region (Ai) (i=1 to 9) in the following manner. An amount Q₁ of exposure on the wafer is determined in proportion to the transmittance TAᵢ. Therefore, it is also possible to replace the transmittance TAᵢ with the amount Qᵢ of exposure. In this case, 100% implies a maximum amount of exposure.

region (A1): 0≦x<a, 0≦y<b

TA₁=100(x/a)·(y/b)[%] (1)

region (A2): a≦x≦a+a₀, 0≦y<b

TA₂=100(y/b)[%] (2)

region (A3): a+a₀<x≦2a+a₀, 0≦y<b

TA₃=100[1−{x−(a+a₀)}/a)]·(y/b)[%] (3)

region (A4): 0≦x<a, b≦y≦b+b₀

TA₄=100(x/a)[%] (4)

region (A5): a≦x≦a+a₀, b≦y≦b+b₀

TA₅=100[%] (5)

region (A6): a+a₀<x≦2a+a₀, b≦y≦b+b₀

TA₆=100[1−{x−(a+a₀)}/a][%] (6)

region (A7): 0≦x<a, b+b₀<y≦2b+b₀

TA₇=100(x/a)·[1−{y−(b+b₀)}/b][%] (7)

region (A8): a≦x≦a+a₀, b+b₀<y≦2b+b₀

TA₈=100[1−{y−(b+b₀)}/b][%] (8)

region (A9): a+a₀<x≦2a+a₀, b+b₀<y≦2b+b₀

TA₉=100[1−{x−(a+a₀)}/a]·[1−{y−(b+b₀)}/b][%] (9)

The external region of the filter portion is as follows.

T(x,y)=0[%] (10)

In this case, a transmittance TA₁ in a region (A1) to be a rectangular corner portion in the lower left part of the filter region has a distribution obtained by multiplying a distribution (x/a) for a one-dimensional outward reduction in the x direction by a distribution (y/a)-for one-dimensional outward reduction in the y direction. Moreover, transmittances TA₃, TA₇ and TA₉ in the areas of lower right, upper left and upper right rectangular corner portions in the filter region have the distribution obtained by multiplying the distribution for a one-dimensional outward reduction in the x direction by the distribution for one-dimensional outward reduction in the y direction, respectively. Furthermore, the transmittance T in a region provided along a BB line in FIG. 4(a) is linearly changed from 0 to 1 (100%) with respect to a position x corresponding to a variation in the position x from 0 to a as shown in FIG. 4(b). Similarly, the transmittance T in a region provided along a CC line in FIG. 4(a) is linearly changed from 0 to 1 (100%) with respect to a position y corresponding to a variation in the position y from 0 to b as shown in FIG. 4(c).

In the present example, the pattern of the reticle R in FIG. 1 is illuminated through the density filter 55 having the transmittance distribution of FIG. 4(a) and the reduced image of the pattern is exposed to a part in one shot region on the wafer W. Then, the reticle on the reticle stage 21 is sequentially exchanged with another reticle and the wafer W is stepped by a predetermined amount through the wafer stage 25. Thereafter, the pattern of the reticle thus exchanged is illuminated through the density filter 55 and the reduced image of the pattern is exposed to another portion in the shot region on the wafer W so that regions (which are also referred to as “stitch portions”) corresponding to the stitch portions 55a to 55d in FIG. 4(a) in the adjacent reduced images are superposed and exposed. Thus, the reduced images of the patterns of the reticles in the shot region on the wafer W are transferred while carrying out a screen stitch in the X and Y directions. The amount of integral exposure which is almost uniform is given over the whole shot region by using the density filter 55.

FIG. 5 shows a large projected image exposed to one shot region on the wafer W in FIG. 1 by the exposure carrying out the screen stitch in the present example. In FIG. 5, rectangular projected images 30A, 30B, 30C and 30D constituted by the reduced images of the patterns of different reticles are exposed with stitch portions 30AB and 30CD in a boundary portion in the X direction and stitch portions 30AC and 30BD in a boundary portion in the Y direction superposed double, respectively. In a rectangular stitch portion 31 in which four projected images 30A to 30D are provided adjacently to each other, furthermore, the rectangular corner portions of the four projected images 30A to 30D are superposed fourfold and exposed. In this case, if the rotation error of the density filter 55 in FIG. 4(a) and the reticle on the reticle stage 21 in FIG. 1 is not completely eliminated by the positioning device 5, it is preferable that the reticle stage 21 should be rotated to set off the rotation error and the coordinate system of the wafer stage 25 should be corrected by the rotation error, and the wafer W should be stepped obliquely based on the corrected coordinate system. Consequently, the error (dose error) of the amount of exposure in the stitch portion can be reduced.

The amount of exposure in each portion of the projected image in FIG. 5 will be evaluated. First of all, in regions having the designations A to D in the central parts of the projected images 30A to 30D, the transmittance of the density filter 55 is 100% so that the amount of exposure is 100%.

Description will be given to the fact that the amount of integral exposure in the stitch portions 30AB, 30BD, 30CD, 30AC and 31 is 100%. For simplicity of the description, a projecting magnification from the density filter 55 in FIG. 4(a) to the wafer W in FIG. 5 is set to 1, and the widths of the stitch portions 30AB and 30CD in the X direction are represented by a and the widths of the stitch portions 30BD and 30AC in the Y direction are represented by b. Moreover, if a point P3 in FIG. 5 is taken as an origin of coordinates (X, Y) and the coordinates of a point P with the point P3 to be the origin are (X, Y), coordinates (X_{A}, Y_{A}), (X_{B}, Y_{B}), (X_{C}, Y_{C}) and (X_{D}, Y_{D}) are as follows when the lower left portions of the projected images 30A, 30B, 30C and 30D are set to be origins.

(X_{A},Y_{A})=(X+(a+a₀),Y) (11)

(X_{B},Y_{B})=(X,Y) (12)

(X_{C},Y_{C})=(X+(a+a₀), Y+(b+b₀)) (13)

(X_{D},Y_{D})=(X, Y+(b+b₀)) (14)

It is assumed that the values of the transmittance TAᵢ which are represented on the coordinates (X_{A}, Y_{A}), (X_{B}, Y_{B}), (X_{C}, Y_{C}) and (X_{D}, Y_{D}) are represented by TAᵢ(A), TAᵢ(B), TAᵢ(C) and TAᵢ(D), respectively.

In this case, if the amounts of exposure of the projected images 30A and 30B in the stitch portion 30AB are represented by AB(A) and AB(B) respectively and the amount of integral exposure obtained by adding the amounts of exposure is represented by AB, the following is obtained by equations (6) and (4). The amounts of exposure in the regions having the designations A to D are set to 100%.

$$\begin{matrix}\begin{matrix}AB ( A ) = {TA}_{6} ( A ) \\ = 100 [ 1 - \{ X + ( a + {a}_{0} ) - ( a + {a}_{0} ) \} / a ] \\ = 100 ( 1 - X / a ) [ \% ]\end{matrix} \\ AB ( B ) = {TA}_{4} ( B ) = 100 ( X / a ) [ \% ] \\ \begin{matrix}AB = AB ( A ) + AB ( B ) \\ = 100 [ \% ]\end{matrix}\end{matrix} \qquad ( 15 )$$

Similarly, the amounts of exposure BD(B) and BD(D) of the projected images 30B and 30D in the stitch portion 30BD and the amount of integral exposure BD are as follows.

BD(B)=TA₂(D)=100(Y/b)[%]

$$\begin{matrix}\begin{matrix}BD ( D ) = {TA}_{8} ( B ) \\ = 100 [ 1 - \{ Y + ( b + {b}_{0} ) - ( b + {b}_{0} ) \} / b ] \\ = 100 ( 1 - Y / B ) [ \% ]\end{matrix} \\ \begin{matrix}BD = BD ( B ) + BD ( D ) \\ = 100 [ \% ]\end{matrix}\end{matrix} \qquad ( 16 )$$

Similarly, the amounts of exposure CD(C) and CD(D) of the projected images 30C and 30D in the stitch portion 30CD and the amount of integral exposure CD are as follows.

$$\begin{matrix}\begin{matrix}CD ( C ) = {TA}_{6} ( C ) \\ = 100 [ 1 - \{ X + ( a + {a}_{0} ) - ( a + {a}_{0} ) \} / a ] \\ = 100 ( 1 - X / a ) [ \% ]\end{matrix} \\ CD ( D ) = {TA}_{4} ( D ) = 100 ( X / a ) [ \% ] \\ \begin{matrix}CD = CD ( C ) + CD ( D ) \\ = 100 [ \% ]\end{matrix}\end{matrix} \qquad ( 17 )$$

Similarly, the amounts of exposure AC(A) and AC(C) of the projected images 30A and 30C in the stitch portion 30AC and the amount of integral exposure AC are as follows.

$$\begin{matrix}AC ( A ) = {TA}_{2} ( A ) = 100 ( Y / b ) [ \% ] \\ \begin{matrix}AC ( C ) = {TA}_{8} ( C ) \\ = 100 [ 1 - \{ Y + ( b + {b}_{0} ) - ( b + {b}_{0} ) \} / b ] \\ = 100 ( 1 - Y / b ) [ \% ]\end{matrix} \\ \begin{matrix}AC = AC ( A ) + AC ( C ) \\ = 100 [ \% ]\end{matrix}\end{matrix} \qquad ( 18 )$$

Moreover, if the amounts of exposure of the four projected images 30A, 30B, 30C and 30D in the stitch portion 31 are represented by ABCD(A), ABCD(B), ABCD(C) and ABCD(D) respectively and the amount of integral exposure thereof is represented by ABCD, the following is obtained by equations (3), (1), (9) and (7).

$$\begin{matrix}\begin{matrix}ABCD ( A ) = {TA}_{3} ( A ) \\ = 100 [ 1 - \{ X + ( a + {a}_{0} ) - ( a + {a}_{0} ) \} / a ] \cdot ( Y / b ) \\ = 100 ( 1 - X / a ) \cdot ( Y / b )\end{matrix} \\ \begin{matrix}ABCD ( B ) = {TA}_{1} ( B ) \\ = 100 ( X / a ) \cdot ( Y / b )\end{matrix} \\ \begin{matrix}ABCD ( C ) = {TA}_{9} ( C ) \\ = 100 [ 1 - \{ X + ( a + {a}_{0} ) - ( a + {a}_{0} ) \} / a ] \cdot [ 1 - \\ \{ Y + ( b + {b}_{0} ) - ( b + {b}_{0} ) \} / b ] \\ = 100 ( 1 - X / a ) \cdot ( 1 - Y / b )\end{matrix} \\ \begin{matrix}ABCD ( D ) = {TA}_{7} ( D ) \\ = 100 ( X / a ) \cdot [ 1 - \{ Y + ( b + {b}_{0} ) - ( b + {b}_{0} ) \} / b ] \\ = 100 ( X / a ) \cdot ( 1 - Y / b ) \\ ABCD = ABCD ( A ) + ABCD ( B ) + ABCD ( C ) + ABCD ( D ) \\ = 100 \{ ( 1 - X / a ) ( Y / b ) + ( X / a ) ( Y / b ) + \\ ( 1 - X / a ) ( 1 - Y / b ) + ( X / a ) ( 1 - Y / b ) \} \\ = 100 [ \% ]\end{matrix}\end{matrix} \qquad ( 19 )$$

By equations (15) to (19), it is apparent that the amount of integral exposure of 100% can be obtained uniformly in the whole regions after the stitch exposure including the rectangular stitch portion 31 in which the four projected images 30A to 30D are adjacent to each other by using the density filter 55 in FIG. 4(a). Subsequently, a circuit pattern having a uniform line width is formed in each shot region on the wafer W through the steps of development, etching, resist separation and the like. By repeating the step of forming a circuit pattern, a semiconductor device having a large area and high function can be mass produced.

In FIG. 5, superposition exposure is not carried out on a region 11 in a peripheral portion. Therefore, the amount of exposure is gradually decreased outward in that state. A region in the stitch portion in which multi-exposure is not carried out is set to be a region on the outside of a pattern region. In that region, it is preferable that light should be shielded by the reticle blind 4 in FIG. 1.

FIG. 6 shows the case in which light is thus shielded by the reticle blind 6. In the case in which the projected images of four patterns are stitched to expose an optional exposure region on a wafer as shown in FIG. 6, the other projected images to be superposed are lacked in an outermost region 11. Therefore, the region 11 becomes an incomplete portion in which the amount of exposure is insufficient.

In this case, for example, the reticle is provided with light shielding bands corresponding to frame-shaped regions 9A to 9D in FIG. 6, and the main control system 24 drives the reticle blind 4 through a driving portion which is not shown such that shadows (images) of edges 41A, 41B, 42A and 42B (see FIG. 2) of the light shielding plates 41 and 42 of the reticle blind 4 in FIG. 1 are included in the range of the light shielding bands. Consequently, illuminating light in a portion to be the incomplete portion is shielded so that the amount of exposure on the wafer is not made nonuniform.

In FIG. 1, moreover, the filter surface of the density filter 55 is present in the vicinity of the conjugate plane P1 with the pattern plane of the reticle R. Therefore, the reticle blind 4 retreats from the plane P1 to a position shifted in the direction of the optical axis of an illuminating optical system so as not to mechanically interfere with the density filter 55. However, a relay optical system for relaying the plane P1 to another conjugate plane may be further provided and the reticle blind 4 may be provided on the conjugate plane in order to prevent the reticle blind 4 from being shifted from the conjugate plane P1 with the pattern plane.

In these cases, it is necessary to set the width of the light shielding band to be provided in the reticle R in general consideration of the amount of blur of the edge of the light shielding plate in the reticle blind 4 through defocus, the control error of the light shielding plate, the mechanical precision of the light shielding plate, the aberration of the optical system from the reticle blind 4 to the reticle R and the amount of distortion of the optical system when defocusing the reticle blind 4.

In addition, the reticle blind 4 may be provided close to the bottom surface of the pattern plane (lower surface) of the reticle R, for example. To the contrary, the density filter 55 may be provided on the bottom surface of the pattern plane of the reticle R to dispose the reticle blind 4 on the conjugate plane P1 with the pattern plane. As a matter of course, the reticle blind 4 or the density filter 55 may be provided on the opposite side (illuminating optical system side) of the pattern plane with respect to the reticle R. Moreover, in the case in which the projecting optical system PL is to re-form the intermediate image of a reticle pattern on the wafer, the reticle blind 4 or the density filter 55 may be shifted from a predetermined surface in the projecting optical system PL in which the intermediate image is to be formed. It is important that the distribution of the amount of light for gradually decreasing the amount of illuminating light outward on the wafer is obtained.

Furthermore, also in the case in which the filter surface of the density filter 55 is defocused by a proper amount with respect to the plane P1 as described above, there is a fear that foreign matters such as dust having a size more than a tolerance might stick onto the filter surface and might be transferred onto the wafer W through the reticle R if the degree of cleanliness in a surrounding environment is low. In order to prevent such a phenomenon, it is desirable that a thin film such as cellulose which does not have an optical influence (a pellicle to be a dustproof layer) should be provided to protect the filter surface.

FIG. 9 shows an embodiment in which a thin film 58 for dustproof is provided on the filter surface P2 of the density filter 55 through a rectangular frame (pellicle frame) 57 formed of metal. In FIG. 9, the filter surface P2 of the density filter 55 and the thin film 58 are provided to interpose the conjugate plane P1 with the pattern surface of the reticle. The reticle blind 4 is provided close to the thin film 58. Consequently, foreign matters do not stick onto the filter surface P2 and the images of the foreign matters sticking to the thin film 58 are defocused and projected onto the reticle without a bad influence. Moreover, a foreign matter checking machine is separately prepared to confirm that the foreign matters exceeding a tolerance stick onto the filter surface P2 or the thin film 58 if necessary. When such foreign matters stick, it is desirable that the density filter 55 should be exchanged with another density filter having no foreign matter sticking thereto.

A glass plate transparent to illuminating light IL which has such a thickness as to be an almost interval between the thin film 58 and the filter surface P2 may be provided in place of the thin film 58. In this case, the glass plate may be fixed in close contact with the filter surface P2.

Moreover, in the case in which the reticle blind 4 is to be provided on a conjugate plane with the reticle which is different from the surface P1, the filter surface P2 of the density filter 55 may be provided toward the reticle side in reverse to the arrangement shown in FIG. 9.

Furthermore, a hole communicating with the outside air is formed in a part of the frame 57 and is constituted such that the thin film 58 is not deformed due to a change in a pressure. The hole is also provided with a chemical filter as well as a HEPA filter so that ions or a silicon based organism can be prevented from entering the filter surface P2.

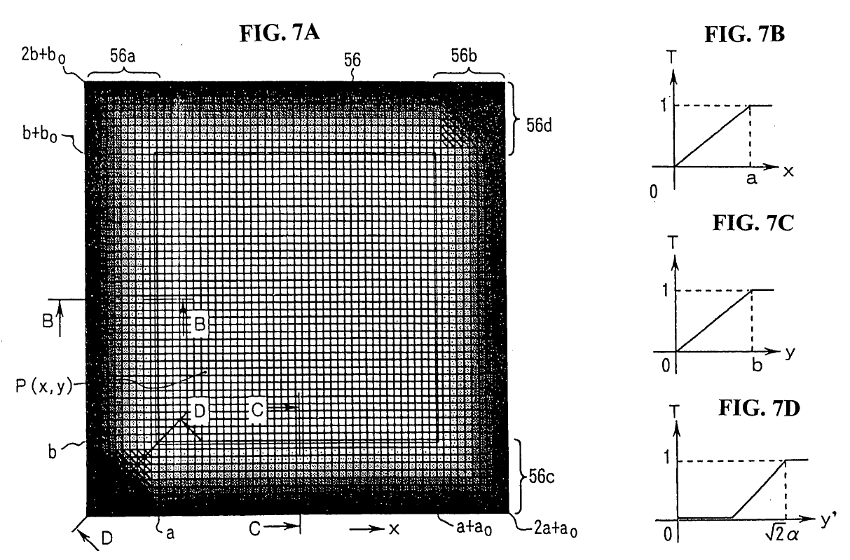

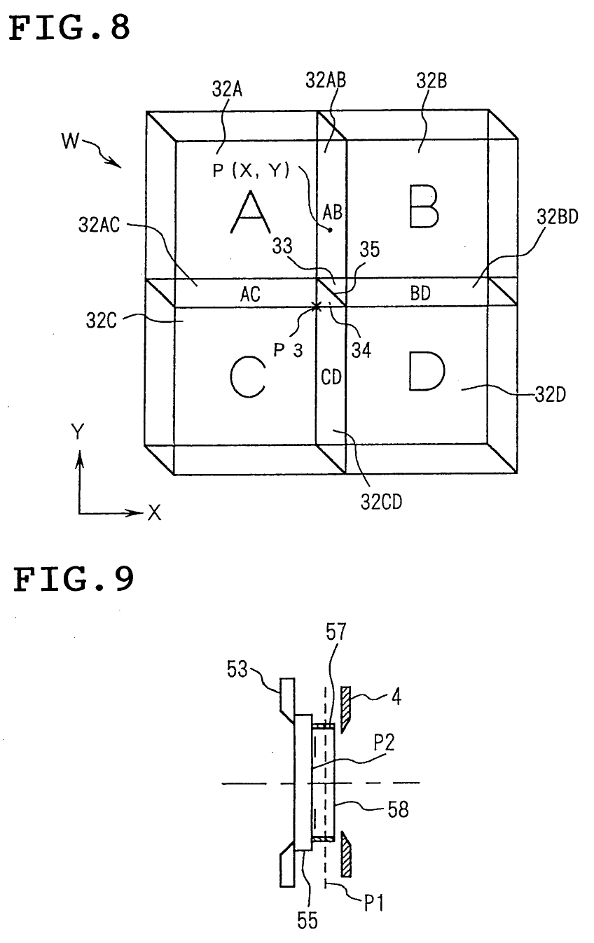

Next, another example of the preferred embodiment of the present invention will be described with reference to FIGS. 7 and 8. Also in the present example, the projected images of a plurality of reticle patterns are exposed onto a wafer while carrying out a screen stitch by using a projection exposing apparatus having basically the same structure as that of the projection exposing apparatus shown in FIG. 1. The present example is different in that the density filter 56 in FIG. 7(a) is used in place of the density filter 55 in FIG. 1 (FIG. 4(a)). In addition, the structures according to the above-mentioned embodiments including variants and the like can be applied. In FIGS. 7 and 8, portions corresponding to those of FIGS. 4 and 5 have the same reference numerals respectively, and description will be given to the distribution of the transmittance of the density filter 56 and the distribution of the amount of exposure which is obtained by carrying out the exposure while performing a screen stitch.

FIG. 7(a) shows the filter portion of the density filter 56 in the present example. In FIG. 7(a), the widths of stitch portions 56a and 56b of both ends in the x direction which are superposed and exposed when carrying out stitch exposure are represented by a, the widths of stitch portions 56c and 56d of both ends in the y direction are represented by b, and the widths in the x and y directions of an internal region surrounded by the stitch portions 56a to 56d are represented by a₀ and b₀, respectively. Moreover, the range in the x and y directions of the filter portion is as follows when the lower left apex of the rectangular filter portion is set to be an origin in the positions x and y.

0≦x≦2a+a₀, 0≦y≦2b+b₀

If a transmittance at a point P having coordinates (x, y) in the filter portion is represented by T (x, y), the transmittance T (x, y) is set to TBᵢ for each region (Bi) (i=1 to 11) in the following manner. Also in the present example, it is also possible to replace the transmittance TBᵢ with the amount Qᵢ of exposure.

region (B1): 0≦x<a, 0≦y<b, and (x/a)+(y/b)>1

TB₁=100{(x/a)+(y/b)−1}[%] (21)

region (B2): a≦x≦a+a₀, 0≦y<b

TB₂=100(y/b)[%] (22)

region (B3): a+a₀<x≦2a+a₀, 0≦y<b, and bx+ay>b(2a+a₀)

TB₃=100(y/b)[%] (23)

region (B4): a+a₀<x≦2a+a₀, 0≦y<b, and bx+ay>b(2a+a₀)

TB₄=100[1−{x−(a+a₀)}/a][%] (24)

region (B5): 0≦x≦a, b≦y≦b+b₀

TB₅=100(x/a)[%] (25)

region (B6): a≦x≦a+a₀, b≦y≦b+b₀

TB₆=100[%] (26)

region (B7): a+a₀<x≦2a+a₀, b≦y≦b+b₀

TB₇=100[1−{x−(a+a₀)}/a][%] (27)

region (B8): 0≦x<a, b+b₀<y≦2b+b₀, and bx+ay≦a(2b+b₀)

TB₈=100(x/a)[%] (28)

region (B9): 0≦x<a, b+b₀<y≦2b+b₀, and bx+ay<a(2b+b₀)

TB₉=100[1−{y−b+b₀)}/b][%] (29)

region (B10): a≦x≦a+a₀, b+b₀<y≦2b+b₀

TB₁₀=100[1−{y−b+b₀)}/b][%] (30)

region (B11): a+a₀<x≦2a+a₀, b+b₀<y≦2b+b₀, and bx+ay≦3ab+ab₀+a₀b

TB₁₁=100[1−{x−(a+a₀)}/a−{y−(b+b₀)}/b][%] (31)

Other regions are as follows.

T(x,y)=0[%]

In this case, a transmittance TB₁ in a region (B1) to be the corner portion of a triangle in the lower left part of the filter region is set based on a value obtained by adding a distribution (x/a) for a one-dimensional outward reduction in the x direction and a distribution (y/a) for a one-dimensional outward reduction in the y direction. As shown in FIG. 7(d), a transmittance T along a line DD in the region (B1) is linearly decreased outward along a position y′ in an oblique direction. A transmittance TB11 in a region (B11) of the corner portion of a triangle in the upper right part of the filter region is also set symmetrically with the transmittance TB₁.

Moreover, the rectangular corner portion in the lower right part of the filter region is divided into adjacent triangular regions (B3) and (B4), and corresponding transmittances TB₃ and TB₄ have a distribution for a one-dimensional outward reduction in the y direction and a distribution for a one-dimensional outward reduction in the x direction, respectively. Similarly, the rectangular corner portion in the upper left part of the filter region is also divided into adjacent triangular regions (B8) and (B9), and corresponding transmittances TB₈ and TB₉ are set to be symmetrical with the transmittances TB₄ and TB₃. Moreover, the transmittance T in a region provided along a BB line in FIG. 7(a) is linearly changed from 0 to 1 (100%) with respect to a position x as shown in FIG. 7(b) and the transmittance T in a region provided along a CC line in FIG. 7(a) is linearly changed from 0 to 1 (100%) with respect to a position y as shown in FIG. 7(c).

Also in the present example, the reticle on the reticle stage 21 in FIG. 1 is illuminated through the density filter 56 having the transmittance distribution of FIG. 7(a) and the reduced image of the pattern of the reticle is exposed to a shot region on the wafer W while carrying out a screen stitch.

FIG. 8 shows a large projected image exposed to one shot region on the wafer W in FIG. 1 by the exposure carrying out the screen stitch in the present example. In FIG. 8, rectangular projected images 32A, 32B, 32C and 32D constituted by the reduced images of the patterns of different reticles are exposed such that stitch portions 32AB and 32CD in a boundary portion in the X direction and stitch portions 32AC and 32BD in a boundary portion in the Y direction are superposed double. Furthermore, a rectangular stitch portion in which four projected images 32A to 32D are provided adjacently to each other is divided into triangular stitch portions 33 and 34 with an oblique boundary line 35 interposed therebetween. In the stitch portion 33, a part of the projected images 32A, 32B and 32D are superposed threefold and exposed. In the stitch portion 34, a part of the projected images 32A, 32C and 32D are superposed threefold and exposed.

The amount of exposure in each portion of the projected image in FIG. 8 will be evaluated. First of all, in regions having the designations A to D in the central parts of the projected images 32A to 32D, the transmittance of the density filter 56 is 100% so that the amount of exposure is 100%. Moreover, the amount of integral exposure of the stitch portions 32AB, 32BD, 32CD and 32AC is 100% in the same manner as in the embodiment shown in FIG. 5. There will be described the fact that the amount of integral exposure of the stitch portions 33 and 34 is also 100%. In the same manner as in FIG. 5, if a point P3 in FIG. 8 is taken as an origin of coordinates (X, Y) and the coordinates of a point P with the point P3 to be the origin are (X, Y), coordinates (X_{A}, Y_{A}), (X_{B}, Y_{B}), (X_{C}, Y_{C}) and (X_{D}, Y_{D}) are as follows when the lower left portions of the projected images 32A, 32B, 32C and 32D are set to be origins.

(X_{A},Y_{A})=(X+(a+a₀), Y) (32)

(X_{B},Y_{B})=(X,Y) (33)

(X_{C},Y_{C})=(X+(a+a₀), Y+(b+b₀)) (34)

(X_{D},Y_{D})=(X,Y+(b+b₀)) (35)

It is assumed that the values of the transmittance TBᵢ which are represented on the coordinates (X_{A}, Y_{A}), (X_{B}, Y_{B}), (X_{C}, Y_{C}) and (X_{D}, Y_{D}) are indicated as TBᵢ(A), TBᵢ(B), TBᵢ(C) and TBᵢ(D), respectively.

In this case, the boundary line 35 of the stitch portions 33 and 34 is represented by (X/a)+(Y/b)=1. Moreover, if the amounts of exposure of the projected images 32A, 32C and 32D in the stitch portion 34 are represented by ABCD1(A), ABCD1(C) and ABCD1(D), they are obtained as follows.

$$\begin{matrix}\begin{matrix}ABCD1 ( A ) = {TB}_{3} ( A ) \\ = 100 ( Y / b )\end{matrix} \\ \begin{matrix}ABCD1 ( C ) = {TB}_{11} ( C ) \\ = 100 [ 1 - \{ X + ( a + {a}_{0} ) - ( a + {a}_{0} ) \} / a ] - \\ \{ Y + ( b + {b}_{0} ) - ( b + {b}_{0} ) \} / b ] \\ = 100 ( 1 - X / a - Y / b )\end{matrix} \\ \begin{matrix}ABCD1 ( D ) = {TB}_{8} ( D ) \\ = 100 ( X / a )\end{matrix}\end{matrix}$$

Accordingly, the amount of integral exposure ABCD1 in the stitch portion 34 is as follows.

$$\begin{matrix}ABCD1 = ABCD1 ( A ) + ABCD1 ( C ) + ABCD1 ( D ) \\ = 100 \{ ( Y / b ) + ( 1 - X / a - Y / b ) + ( X / a ) \} \\ = 100 [ \% ]\end{matrix} \qquad ( 36 )$$

Similarly, if the amounts of exposure of the projected images 32A, 32B and 32D in the stitch portion 33 are represented by ABCD2(A), ABCD2(B) and ABCD2(D), they are obtained as follows.

$$\begin{matrix}\begin{matrix}ABCD2 ( A ) = {TB}_{4} ( A ) \\ = 100 [ 1 - \{ X + ( a + {a}_{0} ) - ( a + {a}_{0} ) \} / a ] \\ = 100 ( 1 - X / a ) \cdot ( Y / b )\end{matrix} \\ \begin{matrix}ABCD2 ( B ) = {TB}_{1} ( B ) \\ = 100 ( X / a + Y / b - 1 )\end{matrix} \\ \begin{matrix}ABCD2 ( D ) = {TB}_{9} ( D ) \\ = 100 [ 1 - \{ Y + ( b + {b}_{0} ) - ( b + {b}_{0} ) \} / b ] \\ = 100 ( 1 - Y / b )\end{matrix}\end{matrix}$$

Accordingly, the amount of integral exposure ABCD2 in the stitch portion 33 is as follows.

$$\begin{matrix}ABCD2 = ABCD2 ( A ) + ABCD2 ( B ) + ABCD2 ( D ) \\ = 100 \{ ( 1 - X / a ) + ( X / a + Y / b - 1 ) + ( 1 - Y / b ) \\ = 100 [ \% ]\end{matrix} \qquad ( 37 )$$

Also in the embodiment shown in FIG. 8, therefore, the same amount of exposure as that in other regions can be obtained in a rectangular region (stitch portions 33 and 34) in which the four projected images 32A to 32D are provided adjacently to each other. Therefore, the uniformity of the amount of exposure can be maintained over the whole projected images.

While the present invention is applied to the case in which a semiconductor device, a liquid crystal display, a plasma display and the like are to be manufactured by a stitch exposing method in the above-mentioned embodiments, the present invention can also be applied to the case in which a working reticle is to be manufactured as a mask by the stitch exposing method. In this case, an original pattern obtained by enlarging the reticle pattern is divided into a plurality of portions and the divided original pattern is drawn on a plurality of master reticles. The reduced images of the patterns of the master reticles are transferred onto a mask substrate such as a glass substrate through the stitch exposing method by the density filters 55 and 56 as in the embodiments. A light shielding film such as chromium is previously formed on the mask substrate and a photoresist is applied thereon. By carrying out development, etching, resist separation and the like after the stitch exposure, it is possible to manufacture a working reticle with high precision and high line width uniformity. In an electron beam exposing apparatus or an EUV exposing apparatus which will be described below, a silicon wafer or the like is used for the mask substrate of the working reticle. In particular, a working reticle of a reflection type is used for the EUV exposing apparatus.

In the projection exposing apparatus according to the above-mentioned embodiments, in the case in which ultraviolet rays having a short wavelength in a vacuum ultraviolet range such as an ArF excimer laser beam are used for the illuminating light IL, a gas having a high transmittance such as a nitrogen gas (N₂) and a helium gas (He) is purged onto the optical path of the illuminating optical path. In this case, in FIG. 9, it is desirable that the gas having a high transmittance should be filled in a space surrounded by the thin film 58, the frame 57 and the density filter 55 or the gas should be caused to flow through an opening provided in the frame 57.

In FIG. 1, moreover, in the case in which a rod integrator is to be used as the illuminance uniforming optical system 2 in FIG. 1, the reticle blind 4 can be disposed close to an emitting surface and the density filter 55 can be provided close to the reticle blind 4. Alternatively, the filter surface of the density filter 55 may be provided on a conjugate plane with the emitting surface between the rod integrator and the reticle or a surface which is slightly shifted from the conjugate plane.

Furthermore, it is desirable that the density filter 55 can be exchanged corresponding to the size and shape of a pattern region on the reticle. In this case, it is preferable that a plurality of density filters having different sizes should be fixed to a turret plate on the positioning device 5 or the like in order to automatically exchange the density filter 55.

Moreover, a device for detecting the mark for alignment of the density filter 55 (or 56) is not restricted to the illuminance sensor 63 but an optical system having at least a light receiving portion may be provided in the wafer stage 25 separately from the illuminance sensor 63, for example, or a special optical system may be incorporated in the illuminating optical system. Furthermore, the illuminating light IL may be used as light for detecting the mark for alignment or a separate light source from the light source 1 may be prepared to use light having substantially the same wavelength as that of the illuminating light IL.

Furthermore, while the present invention is applied to a projection exposing apparatus of a full field exposure type in the above-mentioned embodiments, the present invention can also be applied to the case in which stitch exposure is to be carried out by an exposing apparatus of a proximity type. Moreover, the present invention can also be applied to the case in which the stitch exposure is to be carried out by a projection exposing apparatus of a scanning exposure type such as a step and scan method. The present invention can also be applied to the case in which the stitch exposure is to be carried out by using the EUV exposing apparatus in which extreme ultraviolet rays (EUV rays) such as soft X-rays or X-rays having a wavelength of approximately 5 nm to 15 nm are exposed beams. In the case in which the EUV rays are to be used, a filter of a reflection type in which a reflective film (for example, a multilayered film of molybdenum and silicon or a multilayered film of molybdenum and beryllium) with a predetermined reflectance distribution on a substrate of a reflection type may be used as a density filter (beam attenuating filter) because there is less transmission material.

Moreover, a laser beam having a single wavelength to be illuminating light for exposure in an infrared range or a visible range which is oscillated from a DFB semiconductor laser or a fiber laser may be amplified by a fiber amplifier doped with erbium (Er) (or both erbium and ytterbium (Yb)), for example, and may be converted in a wavelength into ultraviolet rays by using a non-linear optical crystal, and harmonics thus obtained may be used. For example, if the oscillation wavelength of the single wavelength laser ranges from 1.544 μm to 1.553 μm, eightfold harmonics within a range of 193 to 194 nm, that is, ultraviolet rays having a wavelength almost equal to that of the ArF excimer laser can be obtained. If the oscillation wavelength ranges from 1.57 μm to 1.58 μm, tenfold harmonics within a range of 157 to 158 nm, that is, ultraviolet rays having a wavelength almost equal to that of the F₂ laser can be obtained.

Furthermore, an illuminating optical system constituted by an exposure light source, an illuminance uniforming optical system and the like and a projecting optical system are incorporated in an exposing apparatus body to carry out optical regulation, and a reticle stage and a wafer stage which are formed of a large number of mechanical parts are attached to the exposing apparatus body to connect a wiring or a pipe and the density filter 55 according to the above-mentioned embodiments is attached to further carry out general regulation (electric regulation, confirmation of an operation and the like). Consequently, the projection exposing apparatus according to the above-mentioned embodiments can be manufactured. It is desirable that the exposing apparatus should be manufactured in a clean room in which a temperature, a degree of cleanliness and the like are managed.

The present invention is not limited to the above-mentioned embodiments, and the invention may be embodied in various forms without departing from the gist of the present invention. Furthermore, the entire disclosure of Japanese Patent Application No.11-83178 filed on Mar. 26, 1999 including description, claims, drawings and abstract are incorporated herein by reference in its entirety.

### INDUSTRIAL APPLICABILITY

According to the present invention, there is an advantage that the amount of integral exposure in a portion in which four patterns are adjacent to each other can be almost equal to the amounts of integral exposure in other portions when a plurality of patterns are to be transferred while two-dimensionally carrying out a screen stitch. Accordingly, the pattern of a large-sized semiconductor device or the like can be exposed with high precision and a defect is not generated on a stitch portion in a large-sized device which is finally manufactured.

According to the method of manufacturing a mask in accordance with the present invention, it is possible to manufacture a large-sized mask with high precision and high throughput by carrying out a screen stitch without generating a defect.

1. An exposure method which stitches and exposes a plurality of patterns on a substrate, thereby exposing a larger pattern than each of the patterns on the substrate, characterized by comprising:
stitching and exposing a plurality of patterns such that partial regions of the patterns are superposed on each other in a first direction and a second direction which intersect with each other, and
exposing, in a region where four patterns are adjacent to each other, the four patterns such that corner portions of the four patterns are superposed on each other with exposure amounts of the corner portions of the four patterns being respectively set based on a characteristic obtained by multiplying a first characteristic which gradually decreases outward along the first direction by a second characteristic which gradually decreases outward along the second direction when respectively exposing the four patterns.

2. An exposure method as recited in claim 1, characterized in that
when the corner portion of one of the four adjacent patterns is exposed,
an exposure amount at the corner portion is set to have a value proportional to (x/a)·(y/b),
wherein widths in the first and second directions of the corner portion are respectively represented by “a” and “b” and coordinates increasing inward in the corner portion along the first and second directions are respectively represented by “x” and “y” with an apex of the corner portion being set to be a point of origin.

3. An exposure method which stitches and exposes a plurality of patterns on a substrate, thereby exposing a larger pattern than each of the patterns on the substrate, characterized by comprising:
stitching and exposing a plurality of patterns such that partial regions of the patterns are superposed on each other in a first direction and a second direction which intersect with each other, and
exposing, in a region in which four patterns are adjacent to each other, of a first pair of the patterns and a second pair of the patterns which are obliquely opposed to each other, the first pair of patterns with respective rectangular corner portions of the first pair of the patterns being superposed on each other and the second pair of patterns with corner portions of respective triangles of the second pair of patterns being provided adjacently to each other in the rectangular corner portions.

4. An exposure method as recited in claim 3, characterized in that
when respectively exposing the second pair of patterns, exposure amounts of the corner portions of the triangles of the patterns are set based on a characteristic obtained by adding a first characteristic which gradually decreases outward along the first direction and a second characteristic which gradually decreases outward along the second direction, and
when respectively exposing the first pair of patterns, exposure amounts of the corner portions of the patterns are set based on a characteristic which gradually decreases outward one-dimensionally.

5. An exposure apparatus which transfers a pattern of a mask onto a substrate, characterized by comprising:
an illumination optical system which illuminates the mask;
a field stop which is disposed at a substantially conjugate position with respect to a pattern plane of the mask in the illuminating optical system and which serves to set an illuminating region on the mask;
a substrate stage which positions the substrate; and
a beam attenuating filter which is provided on a plane in proximity to the pattern plane of the mask, a conjugate plane with respect to the pattern plane, or a plane in proximity to the conjugate plane and which serves to set a transmittance for illumination light for exposing a region corresponding to at least one corner portion of a pattern region having an external shape substantially parallel with a first direction and a second direction, which intersect each other, of the pattern plane based on a characteristic obtained by multiplying a first characteristic which gradually decreases outward along the first direction by a second characteristic which gradually decreases outward along the second direction.

6. An exposure apparatus which transfers a pattern of a mask onto a substrate, characterized by comprising:
an illumination optical system which illuminates the mask;
a field stop which is disposed at a substantially conjugate position with respect to a pattern plane of the mask in the illuminating optical system and which serves to set an illuminating region on the mask;
a substrate stage which positions the substrate; and
a beam attenuating filter which is provided on a plane in proximity to the pattern plane of the mask, a conjugate plane with respect to the pattern plane, or a plane in proximity to the conjugate plane, wherein
the beam attenuating filter serves to set, of first and second pairs of corner portions, which are opposed obliquely to each other, of a pattern region having an eternal shape substantially parallel with a first direction and a second direction, which intersect each other, of the pattern plane, a transmittance for illumination light for exposure in a region corresponding to the first pair of corner portions based on a first characteristic which gradually decreases outward along the first direction or a second characteristic which gradually decreases outward along the second direction, and to set a transmittance for illumination light for exposure in a region corresponding to a second pair of corner portions, in a triangular region expanded outward along on opposed direction of the pair of corner portions, based on a characteristic obtained by adding the first characteristic which gradually decreases outward along the first direction and the second characteristic which gradually decreases outward along the second direction.

7. An exposure apparatus as recited in claim 5 or 6, characterized by comprising:
a positioning member which positions the beam attenuating filter in a plane perpendicular to an optical axis of illuminating light for exposure, and
a dustproof film disposed in a position set apart from a filter surface of the beam attenuating filter by a predetermined interval.

8. An exposure apparatus as recited in claim 7, characterized in that
the beam attenuating filter is disposed close to the field stop in the illuminating optical system such that the dustproof film is set between the beam attenuating filter and the field stop.

9. An exposure apparatus as recited in claim 8, characterized in that
the beam attenuating filter is disposed apart from a conjugate plane with respect to the pattern plane of the mask by a predetermined distance in the illuminating optical system.

10. An exposure apparatus as recited in claim 5 or 6, characterized by further comprising:
a mark detecting system which detects a mark on the mask and a mark on the beam attenuating filter, and
a driving mechanism which moves the beam attenuating filter based on a result of detection obtained by the mark detecting system.

11. An exposure apparatus as recited in claim 10, characterized in that
the driving mechanism moves the beam attenuating filter in a plane perpendicular to an optical axis of the illuminating optical system.

12. An exposure apparatus as recited in claim 10 or 11, characterized in that
the beam attenuating filter is disposed apart from the conjugate plane with respect to the pattern plane of the mask by a predetermined distance in the illuminating optical system.

13. An exposure apparatus as recited in claim 12, characterized in that
the driving mechanism can move the beam attenuating filter along an optical axis of the illuminating optical system in order to regulate the positional relationship with the conjugate plane and can be inclined with respect to a plane perpendicular to the optical axis.

14. An exposure method which respectively transfers a pattern onto at least two regions having peripheral portions partially superposed on each other on a substrate, characterized in that
in order to obtain at least one of position information and rotation information of a beam attenuating filter which gradually decreases, in a portion in which the at least two regions are superposed on each other, light amount on the substrate of illumination light illuminated on the pattern, at least one mark pattern provided on the beam attenuating filter is detected.

15. An exposure method as recited in claim 14, characterized in that
the relative relationship between the mask on which the pattern is formed and the beam attenuating filter is regulated based on the information obtained.

16. An exposure method as recited in claim 14, characterized in that
at least one of position and inclination of the beam attenuating filter with respect to an optical axis in an optical system in which the beam attenuating filter is disposed is regulated based on the information obtained.

17. An exposure apparatus which respectively transfers a pattern onto at least two regions having peripheral portions partially superposed on each other on a substrate, characterized by comprising:
a beam attenuating filter which gradually decreases light amount on the substrate of illumination light illuminated on the pattern in a portion in which the at least two regions are superposed on each other, and
a detecting device which detects at least one mark pattern provided on the beam attenuating filter in order to obtain at least one of position information and rotation information of the beam attenuating filter.

18. An exposure apparatus as recited in claim 17, characterized by further comprising:
an actuator which drives the beam attenuating filter in order to regulate at least one of position and rotation of the beam attenuating filter.

19. An exposure apparatus as recited in claim 17, characterized in that
the detecting device detects at least one of relative position information and relative rotation information between the beam attenuating filter and a mask on which the pattern is formed.

20. An exposure apparatus as recited in claim 17, characterized in that
the beam attenuating filter is disposed to be shifted from a pattern plane of a mask on which the pattern is formed or a conjugate plane thereof.

21. A mask, characterized in that
a device pattern is formed by screen-stitching of a plurality of mask patterns by the exposure apparatus as recited in any one of claims 5 to 13 and 17 to 20.

22. A method of manufacturing a device, characterized by comprising a step of transferring a device pattern onto a photosensitive substrate by using the exposing method as recited in any one of claims 1 to 4 and 14 to 16.

23. A method of manufacturing a device, characterized by comprising a step of transferring a device pattern onto a photosensitive substrate by using the exposing method as recited in any one of claims 5 to 13 and 17 to 20.

24. A method of manufacturing a mask using the exposing method as recited in any one of claims 1 to 4 and 14 to 16, characterized by comprising a step of transferring a plurality of mask patterns onto a mask substrate while carrying out a screen-stitching by using the exposing method.

25. A method of manufacturing an exposure apparatus which transfers a mask pattern onto a substrate, characterized in that
an illumination optical system which illuminates the mask,
a field stop which is disposed at a substantially conjugate position with respect to a pattern plane of the mask in the illuminating optical system and serves to set an illuminating region on the mask,
a substrate stage which positions the substrate, and
a beam attenuating filter disposed on a plane in proximity to the pattern plane of the mask, a conjugate plane with respect to the pattern plane or a plane in proximity to the conjugate plane, and serves to set a transmittance for illumination light for exposing a region corresponding to at least one corner portion of a pattern region having an external shape substantially parallel with a first direction and a second direction, which intersect each other, of the pattern plane based on a characteristic obtained by multiplying a first characteristic which gradually decreases outward along the first direction by a second characteristic which gradually decreases outward along the second direction,
are assembled with a predetermined positional relationship.

26. A method of manufacturing an exposure apparatus which transfers a mask pattern onto a substrate, characterized in that
an illumination optical system which illuminates the mask,
a field stop which is disposed at a substantially conjugate position with respect to a pattern plane of the mask in the illuminating optical system and serves to set an illuminating region on the mask,
a substrate stage which positions the substrate, and
a beam attenuating filter disposed on a plane in proximity to the pattern plane of the mask, a conjugate plane with respect to the pattern plane or a plane in proximity to the conjugate plane, and serves to set, of first and second pairs of corner portions, which are opposed obliquely to each other, of a pattern region having an external shape substantially parallel with a first direction and a second direction, which intersect each other, of the pattern plane, a transmittance for illumination light for exposure in a region corresponding to the first pair of corner portions based on a first characteristic which gradually decreases outward along the first direction or a second characteristic which gradually decreases outward along the second direction, and to set a transmittance for illumination light for exposure in a region corresponding to a second pair of corner portions, in a triangular region expanded outward along an opposite direction of the pair of corner portions, based on a characteristic obtained by adding the first characteristic which gradually decreases outward along the first direction and the second characteristic which gradually decreases outward along the second direction,
are assembled with a predetermined positional relationship.

27. A method of manufacturing an exposure apparatus which respectively transfers a pattern onto at least two regions having peripheral portions partially superposed on each other on a substrate, characterized in that
a beam attenuating filter which gradually decreases, in a portion in which the at least two regions are superposed on each other, light amount on the substrate of illumination light illuminated on the pattern, and
a detecting device which detects at least one mark pattern provided on the beam attenuating filter in order to obtain at least one of position information and rotation information of the beam attenuating filter,
are assembled with a predetermined positional relationship.
